(19) United States
(12) Patent Application Publication
(10) Pub. No.: US 2010/0325063 A1
(43) Pub. Date: Dec. 23, 2010

(54) SYSTEM, METHOD, AND COMPUTER PROGRAM PRODUCT FOR MARKET-BASED PRICING OF INVESTMENT PRODUCTS WITH GUARANTEED BENEFITS

(75) Inventor: Stephen J. Stone, Valley Vilage, CA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: American Internationl Group, Inc., New York, NY (US)

(21) Appl. No.: 12/817,788

(22) Filed: Jun. 17, 2010

Related U.S. Application Data
(60) Provisional application No. 61/218,325, filed on Jun. 18, 2009.

(51) Int. Cl. G06Q 40/00; G06Q 10/00

(52) U.S. Cl. 705/36 R; 705/400

(57) ABSTRACT

Systems, methods, and computer program products for determining a fee for an investment product having a guaranteed benefit include a means for determining the fee based upon at least one measurement of market volatility.

### CROSS-REFERENCE TO RELATED APPLICATIONS

This patent application claims the benefit of priority to U.S. Provisional Patent Application No. 61/218,325, filed on Jun. 18, 2009, and entitled “Market Based Pricing for Guaranteed Living Benefit on Insurance Products,” which is incorporated in its entirety herein by this reference.

### BACKGROUND OF THE INVENTION

Annuity products, which include, but are not limited to, variable annuities and contingent deferred annuities (CDA), and other insurance/investment products can provide guaranteed benefits for investors based on certain time periods and/or contingencies such as death, loss of investment, poor health or depletion of the account from withdrawals. Typically, the charge for these benefits is set at the time the product in question is issued and is the same for all investors, sometimes varying for a broadly defined class (e.g., age group). A company providing such products and services will typically set a service fee or charge that will be adequate to cover the aggregate risk without underwriting investors for market conditions. The actual cost of the benefits may vary based on actual investment decisions made by the various product owners, such as the investments elected, degree of diversification, frequency of trading, and market volatility.

At any time, market conditions and market volatility may have a considerable impact on the cost of the guaranteed benefit and create risks for the guarantor (typically an insurance company). For example, one risk of the insurance company is the level of market volatility, both actual and implied by option premiums available in the market. Higher volatility levels result in hedging cost increases in the form of increased hedge rebalancing costs or higher option premiums. The company providing the guaranteed benefit takes on market risk because it charges the same fee regardless of the actual cost/risk associated with the then current market conditions.

### SUMMARY OF THE INVENTION

This disclosure is directed to systems, methods, and computer program products for market-based pricing of insurance/investment products with a guaranteed benefit. As market volatility increases, the hedging cost for administrating the insurance product increases. The disclosure provides an investment product that allows for the administrative fees associated therewith to be adjustable in response to hedging cost changes incurred while administering the product. For example, a market-based pricing application can be used in a computing environment and can be embodied in computer readable media bearing instructions for determining the fee charged for a guaranteed benefit of an insurance/investment product based upon a formula tied to the change in a selected indicator of market volatility.

In one embodiment, a system and method are described for determining future fees by basing such fees upon at least one measure of market volatility that correlates with hedging costs. Such indexing enables automatic adjustment of the fee wherein the fee for a given period is related to the level of hedging costs associated with the product that arise from market volatility. Advantageously, such indexing adjusts the fees to be lower when market conditions permit, passing the savings from reduced hedging costs to the customer.

In one aspect of the disclosure, a fee for the guarantee can be based on the rules and constraints of the guarantee. In one embodiment, a fee for the guarantee can be based on an index indicative of market volatility. In other embodiments, the fee for the guarantee can be based on a measure of market volatility based upon a predetermined formula.

In one aspect, the present disclosure describes a computer-implemented system for determining a fee for an investment product having a guaranteed benefit. The system includes a physical computer-readable medium including an investment product pricing program and a processor adapted to execute the investment product pricing program contained on the physical computer-readable medium. The investment product pricing program includes a pricing module adapted to determine the fee based upon at least one measurement of volatility of a market.

In another aspect, the disclosure describes a method for determining a fee for an investment product having a guaranteed benefit comprising, employing a processor to execute computer executable instructions stored on a tangible computer-readable medium to perform a step of calculating the fee based upon at least one measurement of volatility of a market. In still another aspect, the disclosure describes a method for determining a fee for an investment product having a guaranteed benefit comprising, employing a processor to execute computer executable instructions stored on a tangible computer-readable medium to perform a step of adjusting the fee in response to changes in hedging costs associated with providing the guaranteed benefit.

In yet another aspect, the disclosure describes a non-transitory, tangible computer-readable storage medium bearing instructions for determining a fee for an investment product having a guaranteed benefit. The instructions, when executing on one or more computing devices, perform the step of calculating the fee for the product based upon at least one measurement of market volatility.

As will be appreciated, the systems, methods, and computer program products disclosed herein are capable of being carried out in other and different embodiments, and capable of being modified in various respects. Accordingly, it is to be understood that both the foregoing general description and the following detailed description are exemplary and explanatory only and are not restrictive of the invention as claimed.

### BRIEF DESCRIPTION OF THE SEVERAL VIEWS OF THE DRAWINGS

FIG. 1 is a schematic diagram of an embodiment of a computer-implemented system for market-based pricing of insurance products with a guaranteed benefit.

FIG. 2 is a schematic diagram of an embodiment of a computer-implemented system having a physical computer program product including computer-executable instructions for market-based pricing of insurance products with a guaranteed benefit.

FIG. 3 is a flowchart that illustrates steps of an exemplary embodiment of a method of administering a guarantee in keeping with the principles of the present disclosure.

FIG. 4 is a flowchart that illustrates steps of an exemplary embodiment of a method of administering a guarantee in keeping with the principles of the present disclosure.

### DETAILED DESCRIPTION OF EMBODIMENTS OF THE INVENTION

Increased market volatility increases the hedging cost associated with a guaranteed benefit of an insurance/investment product. Aspects of the present disclosure allow an insurance company or other institution (collectively, the “provider”) to reduce its risk in offering a guaranteed benefit on an underlying investment product to its customers by changing the charges or fees associated with the guaranteed benefit based on market volatility and the rules and constraints of the guarantee. The guaranteed benefit may be included in any suitable investment product, including, without limitation, variable annuities and contingent deferred annuities (CDA) that are issued as individual and group, immediate and deferred annuities, for example.

Systems, methods, and computer program products for determining market-based pricing of insurance products with a guaranteed benefit are described herein. Embodiments of a system and a process are disclosed by which the fee for a guaranteed benefit of any suitable investment product (collectively called the “guarantee”) is determined using a market-based pricing application in a computer environment that calculates the fee based on at least one indicator of market volatility. In the following detailed description, references are made to the accompanying drawings that form a part hereof, and in which are shown by way of illustration, specific embodiments or examples. These embodiments may be combined, other embodiments may be utilized, and various changes may be made without departing from the spirit or scope of the present invention. The following detailed description is therefore not to be taken in a limiting sense.

For example, exemplary aspects of the present invention allow the provider of a guaranteed benefit of an annuity product to reduce its risk in providing a minimum guarantee on an underlying investment product. However, the invention is not limited in its application only to annuity products with minimum guarantees. Furthermore, the systems, methods, and computer program products of the present invention are suitable for use with an investment product including any suitable guaranteed benefit, including, without limitation, a living benefit and a death benefit, for example.

One example of an annuity product is a variable annuity that is a single product containing underlying investment options and a guarantee. Charges for the guarantee may further be associated with investment choices so that the guarantee charge is based on market conditions.

Another example is a contingent deferred annuity (CDA) that provides a guaranteed annuitization stream upon depletion of an underlying investment, subject to certain investment and withdrawal rules. The charge for the CDA is based on market conditions.

A further example is a variable annuity having a guaranteed minimum withdrawal benefit (GMWB) rider, the charge for which is adjusted based on a factor correlated to market volatility associated with the cost of hedging activity related to capital the provider maintains to support the minimum benefit withdrawal obligation. One example of a variable annuity product having a GMWB rider attached thereto is provided in U.S. Provisional Patent Application No. 61/148,622, filed on Jan. 30, 2009, and U.S. patent application Ser. No. 12/696,961, filed on Jan. 29, 2010, the contents of which are incorporated herein in their entireties by reference.

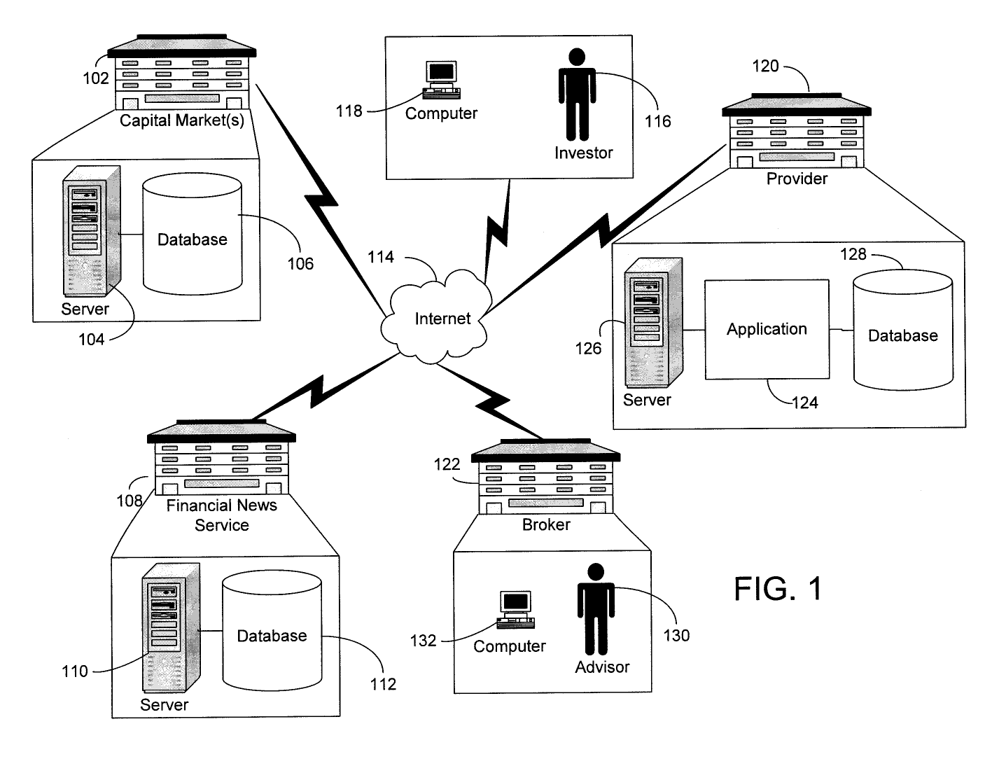

Turning now to the Figures, FIG. 1 is a general overview of system architecture in keeping with the disclosed principles. In the illustrated embodiment, a capital market 102, for example, a stock or commodity exchange such as the New York stock exchange, engages in secondary trading of stocks, commodities, and futures in the normal course of business. As is known, the various transactions are recorded, and transaction data is analyzed to provide various numerical indicators of the state of the market, for example in one or more servers 104 storing and retrieving information from a database 106. Such indicators may include value indices of the current state of the market, such as the Dow Jones Industrial Average, as well as indices indicative of the volatility of the market, such as the Chicago Board Options Exchange (CBOE) Volatility Index® (VIX).

The VIX is a numerical representation of the cost of S&P 500 stock index option prices that tracks the volatility component of such option prices. Other indices exist to track stock markets in the US, such as the VXN, which tracks the Nasdaq, and the VXD, which tracks the Dow Jones Industrial Average, and other indices track overseas markets. As the value of such indices increases, the buy price of options increases, which correlates to an increase in hedging costs. In various embodiments of the present disclosure, any suitable methodology known in the art for computing such a volatility index can be used. Examples of such methodologies (including volatility indices for currency markets and commodity markets, such as oil and gold) are found in the white paper entitled, “The CBOE Volatility Index®—VIX®,” Chicago Board Options Exchange, Inc., 2009. Other examples of volatility indices are promulgated by the CBOE and can be found at the website, http://www.cboe.com/micro/IndexSites.aspx.

Returning now to FIG. 1, aggregate market data provided by the capital markets 102 is typically widely disseminated to the public via financial news services 108. The financial news services 108 may collect raw or processed data from the capital markets 102, analyze such data as required by use of servers 110 and databases 112, and provide financial news reports and other collections of information to the public via printed or electronic channels of communication, for example, the Internet 114.

An investor 116 having access to such information, for example, through the investor's computer 118, may receive such information from the interne 114 and make an informed decision as to whether market volatility is an important factor in the decision of the investor to purchase a guarantee from a provider 120. In the case where the investor 116 has made a purchase decision, the investor 116 may purchase a product with a minimum guarantee from the provider 120 via, for example, a broker 122.

When purchasing the investment product with the guarantee, a customer establishes an account with the broker 122 and purchases a guarantee from a guarantee provider 120, for which the provider charges an initial fee for the guarantee. The account associated with the guarantee has a certain amount of funds to be invested by the investor 116. Parameters and constraints associated with the guarantee may allow the investor 116 the flexibility to invest the funds in a risk diverse array of underlying investments. The investment choices of the investor 116 may be a factor in determining the fees paid by the investor 116 for the guarantee. For example, if the investor 116 makes high risk investment choices, the guarantee provider 120 may implement a software application 124 being executed on a computer server 126 to examine a database 128 of information to calculate a higher fee for the guarantee given the investor's high risk choices. Examples of such a fee calculation method are described in further detail in provisional Patent Application Ser. No. 61/143,725, filed on Jan. 9, 2009, and U.S. patent application Ser. No. 12/636,308, filed on Dec. 11, 2009, the contents of which are incorporated herein in their entireties by this reference.

In accordance with the present disclosure, the fee for the guarantee is based on a predetermined measurement of market volatility. In one embodiment, the measurement is based upon at least one publicly-available index, such as the VIX, for example. In other embodiments, the market volatility measurement is made using a predetermined formula. In yet other embodiments, the fee for the guarantee can be based upon a combination of a predetermined measurement of market volatility and the degree of risk associated with the investment portfolio selected by the investor as described in U.S. Provisional Patent Application No. 61/143,725, filed on Jan. 9, 2009, and U.S. patent application Ser. No. 12/636,308, filed on Dec. 11, 2009, the contents of which are incorporated herein in their entireties by this reference.

In one embodiment, the provider 120 may receive financial news reports and financial market volatility indices from the internet 114, and store those indices in the database 128 on a daily basis. These indices may be input to the application 124 operating on the server 126 to provide daily or otherwise periodic adjustments to the fees charged for the guarantee. These periodic adjustments of the fees may be provided to an investment advisor 130 via computer 132, and may additionally be provided directly to the investor 116 via computer 118.

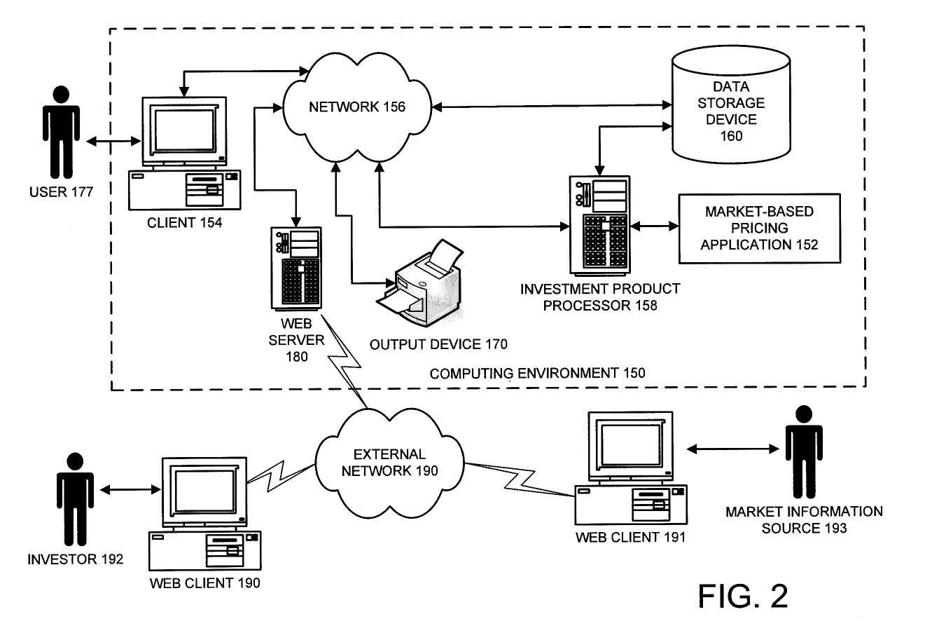

FIG. 2 is an embodiment of a computing environment 150 including a market-based pricing application 152 for market-based pricing of an investment product with a guarantee. The computing environment 150 can include a number of computer systems, which generally can include any type of computer system based on: a microprocessor, a mainframe computer, a digital signal processor, a portable computing device, a personal organizer, a device controller, or a computational engine within an appliance. More specifically, the computing environment 150 can include a client 154, an internal network 156, at least one investment product processor 158 operating the market-based pricing application 152, a data storage device 160, an output device 170, and a web server 180 operatively connected to an external network 190. The client 154, the investment product processor 158, the data storage device 160, the output device 170, and the web server 180 are operatively connected together via the internal network 130.

A plurality of web clients 190, 191 can use the computing environment 150 to interface with the provider operating the computing environment 150. For example, an investor 192 can use the web client 190 to receive information from, and to transmit information to, the provider's computing environment 150 about the underlying investment product. A market information source 193 can use the web client 191 to transmit market volatility data from the web client 191 for use by the market-based pricing application 152. In other embodiments a different communication channel can be established between the capital markets, financial news services, vendors, etc. and the market-based pricing application 152 to transmit market data feeds to the pricing application 152.

The client 154 can be used to communicate with an authorized user 177, to enter investment product account data into the data storage device 160, and/or to execute the market-based pricing application 150. The client 154 can comprise at least one input device. The client 110 can generally include any node on a network including computational capability and including a mechanism for communicating across the network 156.

In one embodiment, the client 154 hosts an application front end of the market-based pricing application 152. The application front end can generally include any component of the market-based pricing application 152 that can receive input from the user 177 or the client 154, communicate the input to the market-based pricing application 152, receive output from the market-based pricing application 152, and present the output to the user 177 or the client 154. In one embodiment, the application front end can be a stand-alone system.

The network 156 can generally include any type of wired or wireless communication channel capable of coupling together computing nodes. Examples of a suitable network 156 include, but are not limited to, a local area network, a wide area network, or a combination of networks.

The investment product pricing processor 158 can generally include any computational node including a mechanism for servicing requests from a client for computational resources, data storage resources, or a combination of computational and data storage resources. Furthermore, the investment product pricing processor 158 can generally include any system that can host the market-based pricing application 152. The investment product pricing processor 158 can generally include any component of an application that can receive input from the web client 190, 191 via the web server 180 or the client 154, process the input, and present the output to the market-based pricing application 152, the web server 180, and/or the data storage device 160. The investment product pricing processor 158 can generally include any component of an application that can process data, interact with the data storage device 160, and execute business logic for the market-based pricing application 152.

The market-based pricing application 152 comprises a computer program product residing on a computer readable medium having a plurality of instructions stored thereon which, when executed by the investment product pricing processor 158, cause the processor 158 to perform steps associated with determining a fee for an investment product having a guarantee wherein the fee is determined based upon an indicator of a selected market volatility. Any suitable computer-readable storage medium can be utilized, including, for example, hard drives, floppy disks, CD-ROM drives, tape drives, zip drives, flash drives, optical storage devices, magnetic storage devices, and the like. The client 154 can be used by an authorized user 177 to help administer the market-based pricing application 152.

The database or data storage device 160 can generally include any type of system for storing data in non-volatile storage. This includes, but is not limited to, systems based upon: magnetic, optical, and magneto-optical storage devices, as well as storage devices based on flash memory and/or battery-backed up memory. In one embodiment, the database 160 contains information associated with the various investment products provided by the provider and market volatility information. This information can be used by the market-based pricing application 152 to periodically determine the fees for providing the guarantees of the investment products. The data storage device 160 can contain a permission database which stores user credentials and permissions specific to each user 177, investor 192, and market information source 193.

The output device 170 can comprise a printer, a display monitor, and a connection to another device, for example. The output device 170 can be used to generate reports for sending to the investment product owner which contain information generated by the market-based pricing application 152. The output device 170 can be used to communicate to the user 177 information about the investment products provided by the provider, which is generated by the market-based pricing application 152.

A report engine can be provided to generate displays of information stored in the data storage device 160 concerning the investment products provided by the provider, which can be viewed using the output device 170, for example. In one embodiment, the report engine further provides pre-configured and/or ad hoc reports relating to the administration fee for investment products with a guarantee provided by the provider.

The web server 180 can provide a suitable web site or other Internet-based graphical user interface which is accessible by the investors (or his agent/broker) 192 and the market information sources 193 providing market volatility data feeds, for example. The web clients 190, 191 can be connected to the web server 180 through the network connection 190 (e.g., Internet, Intranet, LAN, WAN and the like). The web server 180 can use an authentication server in order to validate and assign proper permissions to authorized users of the system. A permission database can store web user credentials and permissions specific to each user, investor, agent, broker, market information source, etc. The web server 180 can be outfitted with a firewall such that requests originating from outside the computing environment pass through the firewall before being received and processed at the web server 180.

In addition to the components discussed above, the computing environment 101 can further include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases.

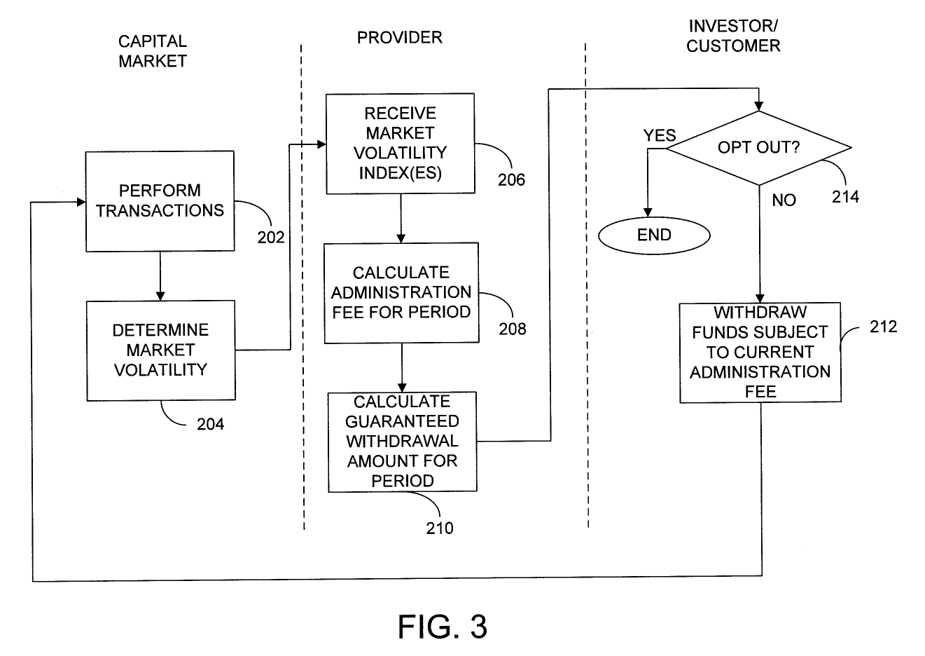

FIG. 3 is a flow diagram that illustrates an exemplary method of an aspect of the present disclosure. The illustrated method is partitioned into process steps occurring in three arenas, namely, the capital market, the provider, and the investor or customer. The process begins with transactions being performed at 202 by the capital markets. Such transactions are meant to generally encompass all relevant trading occurring at markets the provider may be using for benchmarking market volatility as used in the present disclosure. Data relevant to the transactions is analyzed, and along with other, external factors, a market volatility index is determined at step 204. Regarding steps 202 and 204, these portions of the process occur in a large scale in modern trading practices, and are simply illustrated for the purpose of discussion.

Market state and market volatility information, such as, in the form of market indices, for example, are received by the provider at 206 in any suitable form, for example, in the form of electronic information being received via the Internet at one or more servers and being stored in one or more databases maintained by the provider. The market information received at 206 is processed and analyzed using appropriate software programs being executed in the servers of the provider to compute or yield revised fees or charges for providing guarantees at step 208. Such fee or charge revisions may be based on a multitude of factors, but for the purpose of the present disclosure these revised fees are based on, in large part, market information, and specifically to the market volatility indices received at 206.

The provider calculates a revised guaranteed withdrawal benefit at 210, which is based on the revised fees calculated at 208. The revised withdrawal benefit is communicated to the investor at 212. It is noted that, in one embodiment, the investor may receive periodic updates to the variable fees calculated by the provider, or may alternatively be aware of a formula used to calculate the revised fees such that the investor may perform an independent calculation by use of electronic computing means of the revised fee based on publicly accessible market index information.

When calculating the revised withdrawal benefit at 210, certain guidelines may be included within the initial agreement between the provider and the investor, which guidelines may outline and set limits to the variation of the minimum guarantee by contract. In one exemplary embodiment, a particular guaranteed minimum withdrawal benefit may carry a fee of one percentage point (1%), which may also be and which is commonly expressed in terms of basis points (bps), wherein 1% is equal to 100 bps. In this example, a long-term expected volatility of the market may be about 18% at the time of inception of the guarantee.

The agreement at formation of the guarantee may set an incremental change limit (e.g., 10 bps) to the yearly fee paid by the customer for every percentage point the market volatility changes from the level at inception. This incremental change limit may increase or decrease depending on the market indices. Changes in the charges for the guarantee may be applied after a fixed period following inception of the guarantee, for instance, a period of two years. The incremental change of 10 bps may, therefore, be applied for every percentage point change in a rolling average of market volatility. In this example, if the one-year rolling average volatility were to increase from 18% to 25%, the fee would increase by 70 bps, which added to the base fee of 100 bps, would yield a total fee of 170 bps. The contract forming the guarantee in this exemplary embodiment may further include limits to the fee, which would impose a minimum fee, for example 50 bps, and a maximum fee, for example, 250 bps, and may further include limits to the rate of change of the fee, for example, 50 bps per annum.

In one embodiment, the contract forming the guarantee as described herein may contain a clause enabling the investor to opt out from the variable fee arrangement. Hence, an optional decision at 214 ends the process when the investor decides to invoke the opt out clause when such clause is included in his guarantee forming contract. If such a clause is not present, or if the investor decides not to invoke an opt out clause that is included in his contract, the investor may elect to withdraw funds under the current administrative fee at 212.

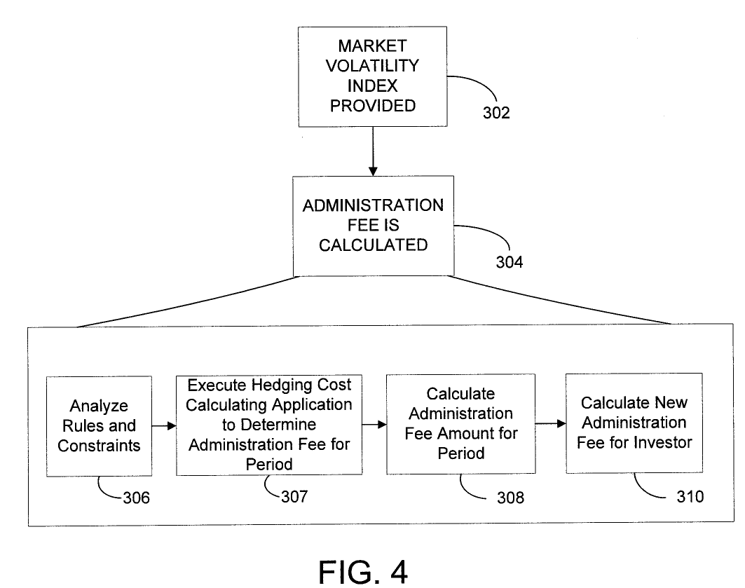

A flow chart illustrating a few of the sub steps or sub-processes executed by a software algorithm operating in the servers of the provider and computing a new or revised fee or charge for the guarantee is shown in FIG. 4. A new or updated market index, or alternatively new and/or updated market performance information, is made available to the provider at 302. The market information is used to calculate a new fee for the guarantee at 304 by use of a specialized software application operating in the servers or computer systems of the provider. Steps 306, 308, and 310, the description of which follows, are sub steps that are included in the calculation of the new fee at 304.

More specifically, at 306, various rules and constraints, such as clauses included in the initial agreement between the provider and the investor, are examined. At a step 307, market data provided at 302 is placed in a hedging file, and a hedging cost calculation algorithm is executed using such data to calculate the product administrative fee for the current period. In light of any such limitations, an adjustment of the fee is calculated at 308. This calculation may include calculation of a rolling average, on a yearly basis, of a specific market index selected by the provider as having the best correlation to the hedging costs of the provider. The adjusted fee is then used to compute a new, total fee for administration of the guarantee at 310. As previously described, the new fee may include a base fee plus any adjustments stemming from changes to the values of the market index or indices being tracked by the provider.

### Example 1

This example demonstrates the administration of a variable annuity contract with a guaranteed living benefit which includes an administration fee that is correlated to market volatility. In this example, the administration fee is charged once every quarter from the effective date of the contract. Once the fee rate is allowed to vary, the amount it varies is regulated by a maximum permissible fee rate quarterly change, a minimum annual fee rate, and a maximum annual fee rate.

The initial annual fee rate is guaranteed not to change for the first benefit year. Subsequently, the fee rate may change quarterly subject to the parameters identified in the fee table below. After the first benefit year, on each benefit quarter anniversary, the provider will (1) deduct the fee in effect for the previous benefit quarter; and (2) determine the fee rate applicable to the next benefit quarter. Any fee adjustment is based on a nondiscretionary formula tied to the change in the VIX. If the value of the VIX increases or decreases from the previous benefit quarter anniversary, the fee rate will increase or decrease accordingly, subject to the maximums and minimums identified in the fee table below.

| Number | Initial | Maximum | Minimum | Maximum Annualized |
|---|---|---|---|---|
| of | Annual | Annual | Annual | Fee Rate Decrease |
| Covered | Fee | Fee | Fee | or Increase Each |
| Persons | Rate | Rate | Rate | Benefit Quarter* |
| One Covered | 1.10% | 2.20% | 0.60% | ±0.25% |
| Person | | | | |
| Two Covered | 1.35% | 2.70% | 0.60% | ±0.25% |
| Persons | | | | |

*The fee rate can increase or decrease no more than 0.0625% each quarter (0.25%/4).

Should the VIX no longer be appropriate or available, the provider would substitute the VIX with another measure of market volatility for determining the fee. If the provider substitutes the VIX, the provider will notify the contract owner; however, the maximum and minimum annual fee rates described in the fee table above are guaranteed for the life of the contract.

If the contract value falls to zero, the fee will no longer be deducted. The provider will not assess the quarterly fee if the contract owner annuitizes the contract or if a death benefit is paid before the end of a benefit quarter. If the guaranteed living benefit is still in effect while the contract value is greater than zero, and the contract owner surrenders the contract, the provider will assess a pro-rata charge for the fee applicable to the benefit quarter in which the surrender occurs if the contract owner surrenders the contract before the end of a benefit quarter. The pro-rata fee is calculated by multiplying the fee by the number of days between the date when the prior fee was last assessed and the date of surrender, divided by the number of days between the prior and the next benefit quarter anniversaries.

### Example 2

This example demonstrates a non-discretionary formula suitable for use in the calculation of the annual fee rate. This example uses the same variable annuity contract with a guaranteed living benefit of Example 1. Accordingly, the fee rate is set for the first benefit year as 1.10% for one covered person and 1.35% for two covered persons.

After the first benefit year, the fee rate is calculated according to the following formula:

Initial Annual Fee Rate+[0.05%×(Value of the VIX as of Market Close on each day the fee is calculated −20)]

The value of the VIX for any given day may be found by using any suitable source, such as by connecting to the Chicago Board Options Exchange website, www.cboe.com, for example. If the value of the VIX increases or decreases from the previous benefit quarter anniversary relative to the baseline of 20, the fee rate will increase or decrease accordingly, subject to the maximums and minimums identified in the table above.

### Example 3

This example demonstrates the administration of a variable annuity contract with a guaranteed living benefit which includes an administration fee that is correlated to market volatility. This example uses the same fee table for a variable annuity contract with a guaranteed living benefit of Example 1 and the non-discretionary formula of Example 2.

In this Example, a variable annuity contract with a guaranteed living benefit is provided for one covered person with an investment of a single purchase payment of $100,000 with no additional Purchase Payments and no withdrawals before the sixteenth benefit quarter. For each of the first sixteen benefit quarters, the value of the VIX, the calculated formula value, annual fee rate, and quarterly fee rate are as follows:

| Benefit | Value | Calculated | Annual | Quarterly |
|---|---|---|---|---|
| Quarter | of VIX | Formula Value* | Fee Rate | Fee Rate** |
| 1st | 24.82 | N/A | 1.10% | 0.2750% |
| 2nd | 21.49 | N/A | 1.10% | 0.2750% |
| 3rd | 24.16 | N/A | 1.10% | 0.2750% |
| 4th | 19.44 | N/A | 1.10% | 0.2750% |
| 5th | 16.88 | 0.94% | 0.94% | 0.2350% |
| 6th | 20.00 | 1.10% | 1.10% | 0.2750% |
| 7th | 25.57 | 1.38% | 1.35% | 0.3375% |
| 8th | 30.22 | 1.61% | 1.60% | 0.4000% |
| 9th | 26.02 | 1.40% | 1.40% | 0.3500 |
| 10th | 22.83 | 1.24% | 1.24% | 0.3100% |
| 11th | 19.88 | 1.09% | 1.09% | 0.2725% |
| 12th | 20.60 | 1.13% | 1.13% | 0.2825% |
| 13th | 14.44 | 0.82% | 0.88% | 0.2200% |
| 14th | 13.41 | 0.77% | 0.77% | 0.1925% |
| 15th | 9.11 | 0.56% | 0.60% | 0.1500% |
| 16th | 16.30 | 0.91% | 0.85% | 0.2125% |

*The Calculated Formula Value equals the number resulting from application of the formula stated above in Example 2. This amount is compared to the minimum and maximum fee and the maximum quarterly fee rate change to determine the annual fee rate each quarter.
**The quarterly fee rate is the annual fee rate divided by 4.

In the fifth benefit quarter, the value of the VIX decreases to 16.88. The annual fee rate is calculated as follows:

Initial Annual Fee Rate+[0.05%×(Value of VIX−20)]

1.10%+[0.05%×(16.88−20)]

0.011+[0.0005×(−3.12)]

0.011+(−0.00156)=0.94%(Calculated Formula Value for annual fee rate)

Next, the calculated annual fee rate is assessed to determine whether it is within the Maximum or Minimum Annual Fee Rate and within the Maximum Quarterly Annualized Fee Rate Increase or Decrease. The annualized quarterly rate change is calculated as follows:

|previous Annual Fee Rate−Calculated Formula Value|

|1.10%−0.94% |=0.16%

Because, the annualized quarterly rate change is less than 0.25%, the Calculated Formula Value need not be modified based upon the Maximum Quarterly Annualized Fee Rate Increase or Decrease (0.25%).

The Calculated Formula Value (0.94%) is higher than the Minimum Annual Fee Rate (0.60%) and is lower than the Maximum Annual Fee Rate (2.20%). Therefore, the Calculated Formula Value need not be modified based upon either the Minimum Annual Fee Rate or the Maximum Annual Fee Rate. Thus, the Annual Fee Rate for the fifth benefit quarter is 0.94%. The quarterly fee rate is 0.2350% (or 0.94% divided by 4).

In the seventh benefit quarter, the value of the VIX increases to 25.57. The annual fee rate is calculated as follows:

Initial Annual Fee Rate+[0.05%×(Value of VIX−20)]

1.10%+[0.05%×(25.57−20)]

0.011+[0.0005×(5.57)]

0.011+(0.002785)=1.38%(Calculated Formula Value for annual fee rate)

The calculated annual fee rate is assessed to determine whether it is within the Maximum or Minimum Annual Fee Rate and within the Maximum Quarterly Annualized Fee Rate Increase or Decrease. The annualized quarterly rate change is calculated as follows:

|previous Annual Fee Rate−Calculated Formula Value|

|1.10%−1.38%|=0.28%

The annualized quarterly rate change using the calculated formula value is greater than the Maximum Quarterly Annualized Fee Rate Increase (0.25%). Thus, the Annual Fee Rate is limited to be exactly 0.25% higher than the previous Annual Fee Rate, which is 1.35% (1.10%+0.25%).

The limited Annual Fee Rate is within the Minimum and Maximum Annual Fee Rates. Therefore, the Quarterly Fee Rate is 0.3375% (or 1.35% divided by 4).

In the thirteenth benefit quarter, the value of the VIX decreases to 14.44. The annual fee rate is calculated as follows:

Initial Fee Rate+[0.05%×(Value of VIX−20)]

1.10%+[0.05%×(14.44 −20)]

0.011+[0.0005×(−5.56)]

0.011+(−0.00278)=0.82%(Calculated Formula Value for annual fee rate)

The calculated annual fee rate is assessed to determine whether it is within the Maximum or Minimum Annual Fee Rate and within the Maximum Quarterly Annualized Fee Rate Increase or Decrease. The annualized quarterly rate change is calculated as follows:

|previous Annual Fee Rate−Calculated Formula Value|

|1.13%−0.82%|=0.31%

The annualized quarterly rate change using the calculated formula value is greater than the Maximum Quarterly Annualized Fee Rate Decrease (0.25%). Thus, the Annual Fee Rate is limited to be exactly 0.25% lower than the previous Annual Fee Rate, which is 0.88% (1.13%−0.25%).

In the fifteenth benefit quarter, the value of the VIX decreases to 9.11. The annual fee rate is calculated as follows:

Initial Fee Rate+[0.05%×(Value of VIX−20)]

1.10%+[0.05%×(9.11 −20)]

0.011+[0.0005×(−10.89)]

0.011+(−0.005445)=0.56%(Calculated Formula Value for annual fee rate)

The calculated annual fee rate is assessed to determine whether it is within the Maximum or Minimum Annual Fee Rate and within the Maximum Quarterly Annualized Fee Rate Increase or Decrease. The annualized quarterly rate change is calculated as follows:

|previous Annual Fee Rate−Calculated Formula Value|

|0.77%−0.56%|=0.21%

Because, the annualized quarterly rate change is less than 0.25%, the Calculated Formula Value need not be modified based upon the Maximum Quarterly Annualized Fee Rate Increase or Decrease (0.25%).

The calculated Annual Fee Rate of 0.56% is lower than the Minimum Annual Fee Rate (0.60%). Therefore, the Annual Fee Rate is increased from the calculated value to be exactly the Minimum Annual Fee Rate, which is 0.60%.

After the sixteenth benefit quarter, the annual fee rate will continue to increase or decrease depending on the movement of the value of the VIX. If the contract value falls to zero before the feature has been terminated, the fee will no longer be deducted.

It would be apparent to a person of ordinary skill in the art that embodiments of the invention include changing charges and benefits for the investment products described herein for one or more customers. Consequently, aspects of the exemplary computer system and computer implemented method described in the disclosure allow a provider to calculate the charges and benefits for the investment products described herein for its many customers and the many different market conditions that may appear during the life of a guarantee. In addition, embodiments of the invention physically transform (by either increasing or decreasing) the charges, hence the money received by the provider, for the investment products described herein based on changing market conditions. The provider may notify each customer of a change in the administration fee for the guaranteed benefit through means described in the disclosure as well as by a physical invoice.

In other embodiments, systems and methods for determining pricing information for an investment product having a guaranteed benefit may be implemented on various types of computer architectures, such as for example on a single general purpose computer or workstation, or on a networked system, or in a client-server configuration, or in an application service provider configuration. Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform methods described herein. Other implementations may also be used, however, such as firmware or even appropriately designed hardware configured to carry out the methods and systems described herein.

The systems' and methods' data (e.g., associations, mappings, etc.) may be stored and implemented in one or more different types of computer-implemented ways, such as different types of storage devices and programming constructs (e.g., data stores, RAM, ROM, flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality (e.g., the golden copy security pricing compilation functionality) may be located on a single computer or distributed across multiple computers depending upon the particular circumstances surrounding its use (e.g., located on client and/or server computers).

In various embodiments, methods for determining pricing information for an investment product having a guaranteed benefit in accordance with the principles of the present disclosure operate as software programs running on a computer processor. Dedicated hardware implementations including, but not limited to, application-specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

In various embodiments, a program for determining pricing information for an investment product having a guaranteed benefit in accordance with the principles of the present disclosure can take the form of a computer program product on a tangible, computer-readable storage medium having computer-readable program code means embodied in the storage medium. The software implementations of the program for determining pricing information for an investment product having a guaranteed benefit as described herein can be stored on any suitable tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to email or other self-contained information archive or set of archives is considered a distribution medium equivalent to a tangible storage medium. Accordingly, a tangible storage medium includes a distribution medium and art-recognized equivalents and successor media, in which the software implementations herein are stored.

The present invention has been described in particular detail with respect to a limited number of embodiments. Those of skill in the art will appreciate that the invention may additionally be practiced in other embodiments. The particular naming of the components, capitalization of terms, the attributes, data structures, or any other programming or structural aspect is not mandatory, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of the above description present the feature of the present invention in terms of algorithms and symbolic representations of operations on information. These algorithmic descriptions and representations are the means used by those skilled in the art to most effectively convey the substance of their work to others skilled in the art. These operations, while described functionally or logically, are understood to be implemented by computer programs. Furthermore, it has also proven convenient at times, to refer to these arrangements of operations as modules or code, without loss of generality.

It should be borne in mind, however, that all of these and similar terms are to be associated with the appropriate physical quantities and are merely convenient labels applied to these quantities. Unless specifically stated otherwise as apparent from the present discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention can be embodied in software, firmware or hardware, and when embodied in software, can be downloaded to reside on and be operated from different platforms used by real time network operating systems.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description above. It should be understood that a variety of programming languages may be used to implement the teachings of the present disclosure as described herein, and any references to specific languages are exemplary to aid one skilled in the art to make and use the invention.

The language used in the specification has been principally selected for readability and instructional purposes. Accordingly, the disclosure is intended to be illustrative, but not limiting, of the scope of the invention.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The teens “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. For example, embodiments of the invention can be applied to any form of investment insurance that allows for investments in a finite set of alternatives. Other embodiments of the invention can be applied to 403(b) accounts, 401(k) accounts, and non-VA guarantees on mutual funds or other investments.

The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A computer-implemented system for determining a fee for an investment product having a guaranteed benefit comprising:
a physical computer-readable medium including an investment product pricing program; and
a processor adapted to execute the investment product pricing program contained on the physical computer-readable medium;
wherein the investment product pricing program includes a pricing module having computer executable instructions adapted to determine the fee based upon at least one measurement of volatility of a market.

2. The system of claim 1, wherein the pricing module is adapted to determine the fee based upon an index indicative of the market volatility.

3. The system of claim 2, wherein the pricing module is adapted to determine the fee based upon a formula including the index indicative of the market volatility.

4. The system of claim 1, wherein the pricing module is adapted to determine the fee based upon a formula including a numerical measure of market volatility.

5. A method for determining a fee for an investment product having a guaranteed benefit comprising, employing a processor to execute computer executable instructions stored on a tangible computer-readable medium to perform a step of:
calculating the fee based upon at least one measurement of volatility of a market.

6. The method of claim 5, wherein the fee is calculated based upon an index indicative of the market volatility.

7. The method of claim 6, wherein the fee is calculated based upon a formula including the index indicative of the market volatility.

8. The method of claim 5, wherein the fee is calculated based upon a formula including a numerical measure of market volatility.

9. The method of claim 8, wherein the computer executable instructions stored on the tangible computer-readable medium perform a step of:
setting the fee to a predetermined minimum fee if the fee calculated based upon the formula is less than the minimum fee.

10. The method of claim 8, wherein the computer executable instructions stored on the tangible computer-readable medium perform a step of:
setting the fee to a predetermined maximum fee if the fee calculated based upon the formula is more than the maximum fee.

11. The method of claim 9, wherein the computer executable instructions stored on the tangible computer-readable medium perform a step of:
setting the fee to a predetermined maximum fee if the fee calculated based upon the formula is more than the maximum fee.

12. The method of claim 5, wherein the computer executable instructions stored on the tangible computer-readable medium perform a step of:
periodically re-calculating the fee based upon at least one measurement of volatility of a market.

13. The method of claim 12, wherein the computer executable instructions stored on the tangible computer-readable medium perform a step of:
limiting the change in the fee between the present fee and the previous fee to a predetermined increase or decrease.

14. A method for determining a fee for an investment product having a guaranteed benefit comprising, employing a processor to execute computer executable instructions stored on a tangible computer-readable medium to perform a step of:
adjusting the fee in response to changes in hedging costs associated with providing the guaranteed benefit.

15. A tangible computer-readable storage medium bearing instructions for determining a fee for an investment product having a guaranteed benefit, the instructions, when executing on one or more computing devices, perform the step of calculating the fee for the product based upon at least one measurement of market volatility.

16. The computer-readable storage medium of claim 15, wherein the fee is calculated based upon an index indicative of the market volatility.

17. The computer-readable storage medium of claim 16, wherein the fee is calculated based upon a formula including the index indicative of the market volatility.

18. The computer-readable storage medium of claim 15, wherein the fee is calculated based upon a formula including a numerical measure of market volatility.

19. The computer-readable storage medium of claim 18, wherein the computer executable instructions perform a step of:
setting the fee to a predetermined minimum fee if the fee calculated based upon the formula is less than the minimum fee.

20. The computer-readable storage medium of claim 18, wherein the computer executable instructions perform a step of:
setting the fee to a predetermined maximum fee if the fee calculated based upon the formula is more than the maximum fee.

21. The computer-readable storage medium of claim 19, wherein the computer executable instructions perform a step of:
setting the fee to a predetermined maximum fee if the fee calculated based upon the formula is more than the maximum fee.

22. The computer-readable storage medium of claim 15, wherein the computer executable instructions perform a step of:
periodically re-calculating the fee based upon at least one measurement of the volatility of a market when the fee is re-calculated.

23. The computer-readable storage medium of claim 22, wherein the computer executable instructions perform a step of:
limiting the change in the fee between the present fee and the previous fee to a predetermined increase or decrease.
